(19) United States
(12) Patent Application Publication
(10) Pub. No.: US 2014/0331764 A1
(43) Pub. Date: Nov. 13, 2014

(54) System for Measuring a Liquid Surface Level within a Storage Tank

(71) Applicants: Paulus M. Beuger, Charlotte, NC (US); Bernard Drew, Savannah, GA (US)

(72) Inventors: Paulus M. Beuger, Charlotte, NC (US); Bernard Drew, Savannah, GA (US)

(21) Appl. No.: 14/274,547

(22) Filed: May 9, 2014

Related U.S. Application Data
(60) Provisional application No. 61/821,364, filed on May 9, 2013.
(60) Provisional application No. 61/870,893, filed on Aug. 28, 2013.

(51) Int. Cl. G01F 23/72

(52) U.S. Cl. CPC G01F 23/72
USPC 73/311; 73/313

(57) ABSTRACT

A measuring system places a plurality of sensor arrays in a lateral enclosure, the sensors being able to measure movement of magnetic floats from which a liquid level can be calculated. The plurality of sensor arrays is serially positioned in the lateral enclosure in order to enable monitoring of the entire lateral enclosure. The plurality of sensor arrays uses a circuit board with a plurality of a Hall-Effect sensors and a microcontroller to detect the magnetic floats. The circuit boards are also provided with male and female interconnectors to allow an arbitrary sensor array to be connected to an adjacent sensor array; through these connections each of the plurality of sensor arrays is grouped and in combination able to monitor the entire area of the lateral enclosure. A segmented construction for the lateral enclosure is also possible, with each segment containing one of the sensor arrays.

The current application claims a priority to the U.S. Provisional Patent application Ser. No. 61/821,364 filed on May 9, 2013 and to the U.S. Provisional Patent application Ser. No. 61/870,893 filed on Aug. 28, 2013.

### FIELD OF THE INVENTION

The present invention generally relates to a design of a segmented and configurable sensor apparatus to accurately measure the level of a liquid or liquids within a fixed storage tank. Such applications include the measurement of oil and water in storage tanks used in the petroleum industry or other applications such as municipal water systems.

### BACKGROUND OF THE INVENTION

Current technologies utilize three methods to measure liquids in petroleum tanks: dipsticks (which measures a liquid level through a human operator), radar (which measures the liquid level by measuring the distance between the transmitter and the surface of the liquid within the tank), and various forms of floats (which measures the liquid level by proportionately changing the electrical resistance of a variable resistor or resistor divider).

Each of these techniques has advantages and disadvantages. The manual method using a dipstick involves significant cost for the human operator and the inability to monitor levels on a real time or quasi-real time basis. There is also the possibility of measurement error inherent with dipstick measurements. The radar method is expensive, typically cannot differentiate between different types of liquid, such as oil and water. While in theory, the accuracy of radar can be excellent, and in practice, these radar systems have not proven to be sufficiently accurate or reliable. Systems utilizing floats have used traditional analog technology to vary the value of a resistor or a potentiometer based on the position of the float. Such systems have several advantages: low cost, simple, reasonable accuracy, and reliable. Traditional systems utilizing floats also have many disadvantages: They require medium to high power to operate due to the low impedances involved, they cannot interpolate readings to obtain higher accuracy, they require subsequent signal processing to interface with computer monitoring and control systems, the resistance elements can vary with temperature affecting accuracy, and they are subject to noise and interference due to the analog technology employed.

Therefore, the objective of the present invention is to provide a unique and novel design that overcomes many of the disadvantages of traditional float-based systems. The present invention's use of digital Hall Effect sensors, microcontrollers, software, and advanced float designs is central to the novel design described hereinafter.

### BRIEF DESCRIPTION OF THE DRAWINGS

FIG. 1 is a schematic overview of the present invention without the magnetic floats.

FIG. 2 is a schematic overview of the present invention with the magnetic floats.

FIG. 3 is a schematic overview of one sensor array for the present invention.

FIG. 4 is a schematic overview of two sensor arrays interlocking with each other.

FIG. 5 is a schematic overview for a segmented portion in one embodiment of the present invention.

FIG. 6 is a top schematic overview for the segmented portion.

FIG. 7 is a bottom schematic overview for the segmented portion.

FIG. 8 is a schematic overview of two segmented portions interlocking with each other.

### DETAILED DESCRIPTION OF THE INVENTION

All illustrations of the drawings are for the purpose of describing selected versions of the present invention and are not intended to limit the scope of the present invention.

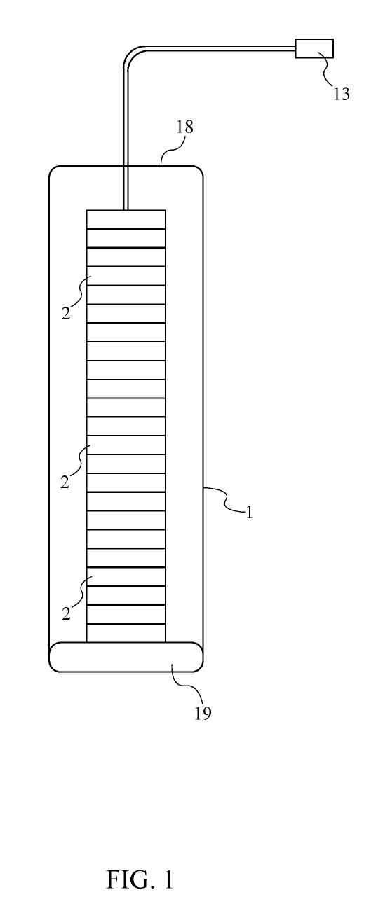

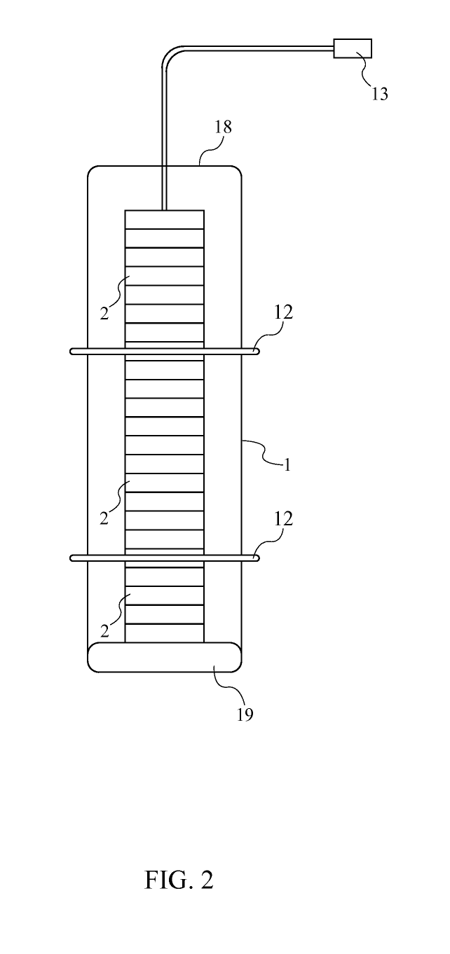

As can be seen in FIGS. 1 and 2, the present invention is a system for measuring a liquid surface level within a storage tank. The present invention must be positioned plumb within the storage tank in order to receive an accurate liquid level reading. The present invention mainly comprises a lateral enclosure 1, a plurality of sensor arrays 2, at least one magnetic float 12, and a central controller 13. The lateral enclosure 1 is used to surround and to protect the internal components of the present invention from the contents of the storage tank. The lateral enclosure 1 is designed for exposure to liquids at high temperature and needs to be made of a non-magnetic material. The magnetic float 12 is exteriorly positioned around and is slidably engaged to the lateral enclosure 1, which allows the movement of the magnetic float 12 to be up and down the lateral enclosure 1. The height of the magnetic float 12 indicates the liquid surface level within the storage tank because the magnetic float 12 will be buoyant upon the liquid held within the storage tank. The vertical position of the magnetic float 12 is detected by the plurality of sensor arrays 2, which are serially mounted within the lateral enclosure 1.

The serial positioning of the plurality of sensor arrays 2 allows the present invention to detect the magnetic float 12 anywhere along the lateral enclosure 1. Moreover, the lateral enclosure 1 needs to be cross-sectionally shaped in such a way to prevent the magnetic float 12 from rotating about the lateral enclosure 1 because the orientation of the magnetic field from the magnetic float 12 in relation to the plurality of sensor arrays 2 is important to receiving accurate measurement readings. Each of the plurality of sensor arrays 2 is a set of electronic components, which means the lateral enclosure 1 must provide a liquid-tight seal against the contents of the storage tank. In addition, each of the plurality of sensor arrays 2 is made at the same portable size so that the plurality of sensor arrays 2 can be easily transported to the location of the storage tank and can be easily assembled to accommodate the appropriate height within the storage tank. Thus, the plurality of sensor arrays 2 is designed to be daisy-chained together. In the preferred embodiment of the present invention, each of the plurality of sensor arrays 2 is sized to measure one foot of length.

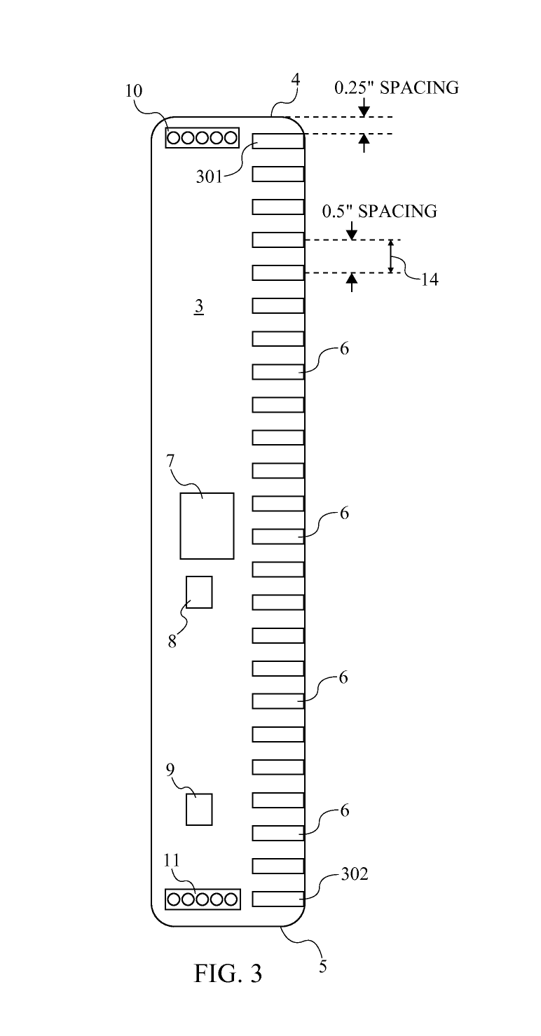

The plurality of sensor arrays 2 is designed to communicate with each other and to detect their surroundings along the entire length of the present invention. Consequently, each of the plurality of sensor arrays 2 comprises a circuit board 3, a plurality of Hall-Effect sensors 6, a microcontroller 7, a temperature sensor 8, a regulator 9, a male interconnector 10, and a female interconnector 11, all of which are shown in FIG. 3. The circuit board 3 is used as a mounting board for the electronic components of each sensor array 2. Each of the plurality of Hall-Effect sensors 6 is a transducer that varies its output voltage in response to a magnetic field, which is produced by the magnetic float 12 in the present invention. Thus, the plurality of Hall-Effect sensors 6 is serially mounted onto the circuit board 3 and is aligned to be along the longitudinal enclosure so that one of the Hall-Effect sensors 6 will be triggered if the magnetic float 12 travels within the vicinity of that particular sensor array. In addition, the plurality of Hall-Effect sensors 6 is systematically spaced apart from each other by a set interval 14 on the circuit board 3, which allows the present invention to accurately identify the position of the magnetic float 12 along the height of that particular sensor array. The plurality of Hall-Effect sensors 6 is capable of a resolution of half of the set interval 14 because two of the Hall-Effect sensors 6 will be triggered if the magnetic float 12 is located between a pair on Hall-Effect sensors 6 for that particular sensor array. In the preferred embodiment of the present invention, each of the plurality of sensor arrays 2 has 24 Hall-Effect sensors 6 that are serially spaced apart from each other by a set interval 14 of 0.5 inches. In addition, the microcontroller 7 is electrically connected to each of the plurality of Hall-Effect sensors 6 so that the microcontroller 7 is able to receive and process a detection signal from any of the Hall-Effect sensors 6. The microcontroller 7 is also converts an analog detection signal into a digital detection signal that can be interpreted by the central controller 13, which is used to receive and process data from the plurality of sensor arrays 2. Thus, the microcontroller 7 for each of the sensor arrays 2 is communicably coupled to the central controller 13. The microcontroller 7 is also a low power device, which improves the energy efficiency of each of the sensor arrays 2.

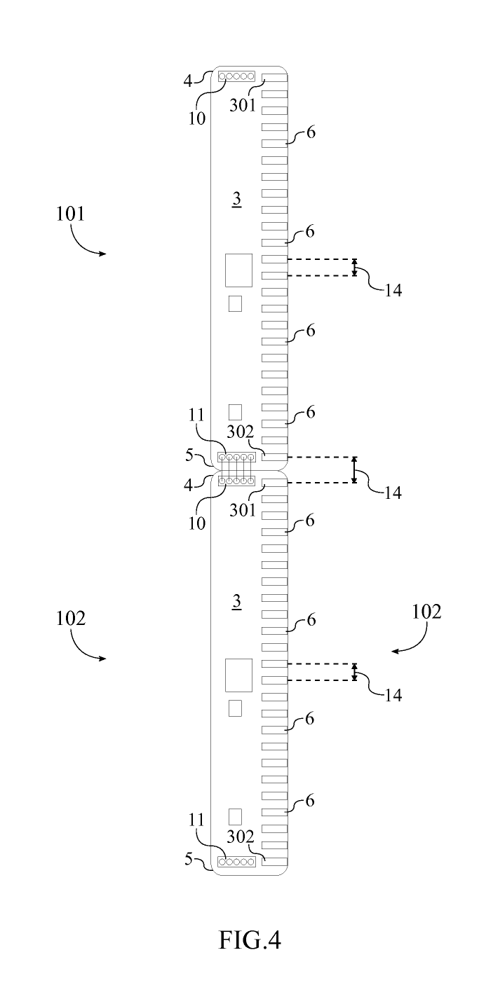

The microcontroller 7 is able to manage other functions and processes for some of the other components in a sensor array 2. The temperature sensor 8 is used to measure the temperature of the liquid held within the storage tank, which allows the present invention to measure the temperature gradient along the entire height of the storage tank through the plurality of sensor arrays 2. Consequently, the temperature sensor 8 is mounted onto the circuit board 3 and is electronically connected to the microcontroller 7 so that the central controller 13 is able to receive the temperature reading from the location of each of the sensor arrays 2. In addition, the regulator 9 is used to maintain proper voltage levels for an analog detection signal being sent from one of the Hall-Effect sensors 6 to the microprocessor. Consequently, the regulator 9 is mounted onto the circuit board 3, and the microcontroller 7 is electronically connected to each of the plurality of Hall-Effect sensors 6 through the regulator 9. In the preferred embodiment of the present invention, the regulator 9 is a 2.5-volt regulator 9. Furthermore, the male interconnector 10 and the female interconnector 11 provide the means to daisy-chain the plurality of sensor arrays 2 together, which is shown in FIG. 4. In order to daisy-chain the plurality of sensor arrays 2, the male interconnector 10 and the female interconnector 11 are mounted onto the circuit board 3, opposite to each other. This way the male interconnector 10 of an arbitrary sensor array 101 can electronically engage the female interconnector 11 of the adjacent sensor array 102.

In the preferred embodiment of the present invention, the male interconnector 10 is a 5-pin connector, and the female interconnector 11 is a 5-pin receiver, where the 5-pins consist of: the power (+3.3 Volts), the ground, the inter-integrated circuit (I2C) bus data, the I2C bus clock, and the digital notification signal. The 3.3-volt power and the ground rails are used to electrically power each of the sensor arrays 2. The I2C bus data and the I2C bus clock rails are used to as a communication link between the sensor arrays 2 and the central controller 13. The digital notification signal rail is used to alert the central controller 13 of a positional change in the magnetic float 12. Also in the preferred embodiment, the typical maximum number of sensor arrays that can be daisy-chained together is 32, but a larger number of daisy-chained sensor arrays could be possible through the use of bus repeaters.

During manufacture, the microcontroller 7 is programmed with a boot loader, application software, and a section number starting at the bottom. For example, the bottom sensor array for a 22 foot sensor array would be numbered 1, while the top sensor array would be numbered 22, and all sensor arrays in between would be sequentially numbered. The boot loader would allow the application software to be upgraded in the field.

As can be seen in FIG. 2, the present invention can be configured to accommodate a storage tank that contains a number of different liquids such as a three-phase separator. Thus, the present invention would need to comprise a plurality of magnetic floats 12, each of which has a different buoyancy weight for a specific kind of liquid. For example, the three-phase separator contains crude oil, an oil-water emulsion, and pure water. Thus, the present invention would use one magnetic float 12 for the surface level of the crude oil, another magnetic float 12 for the surface level of the oil-water emulsion, and another magnetic float 12 for the surface level of the water. These magnetic floats 12 are “tuned” to maintain neutral buoyancy in liquids of specific gravities of crude oil, an oil-water emulsion, and pure water. By making differential measurements between these magnetic floats 12, the depth of each liquid layer can be calculated with precision. Once the depth of each layer is known, the amount of each liquid may be easily calculated based on the known dimensions of the storage tank.

The present invention has a non-segmented embodiment and a segmented embodiment. In the non-segmented embodiment, the primary feature is that the lateral enclosure 1 is non-segmented or is one continuous piece of tubing. This embodiment of the present invention further comprises a top cap 18 and a bottom cap 19, which are used to create a liquid-tight seal at both the top and bottom openings of the lateral enclosure 1. Thus, the top cap 18 is positioned adjacent and perimetrically connected to the lateral enclosure 1. In addition, the bottom cap 19 is positioned adjacent to the lateral enclosure 1 opposite to the top cap 18 and is perimetrically connected to the lateral enclosure 1. The combination of the top cap 18, the bottom cap 19, and the lateral enclosure 1 forms a liquid-tight enclosure for the plurality of sensor arrays 2. For the non-segmented embodiment, the first Hall-Effect sensor 301 and the last Hall-Effect sensor 302 on each of the sensor arrays 2 has a specific configuration in order to properly identify the positioning of the magnetic float 12 in between a pair of sensor arrays. The first Hall-Effect sensor 301 is only offset from the top board edge 4 of the circuit board 3 by half of the set interval 14, and the last Hall-Effect sensor 302 is only offset from the bottom board edge 5 of the circuit board 3 by half of the set interval 14. In the preferred embodiment, the set interval 14 is 0.5 inches, which means that the first Hall-Effect sensor 301 is offset from the top board edge 4 by 0.25 inches and that the last Hall-Effect sensor 302 is offset from the bottom board edge 5 by 0.25 inches.

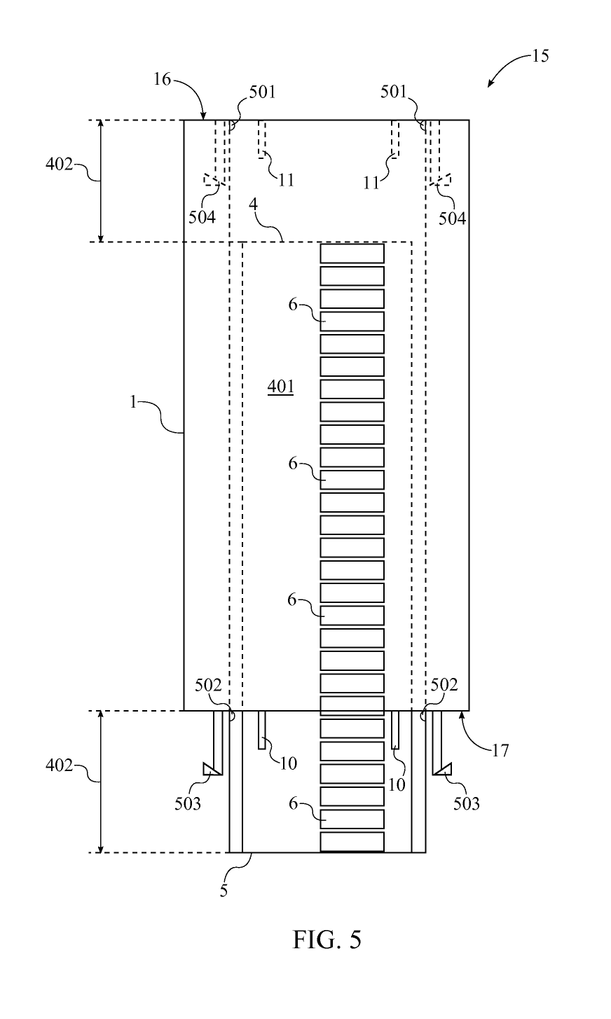

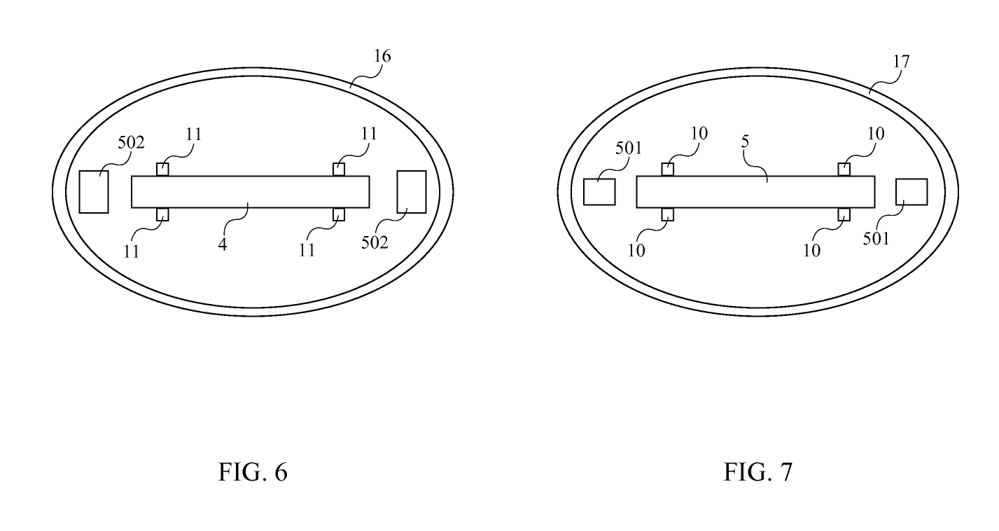

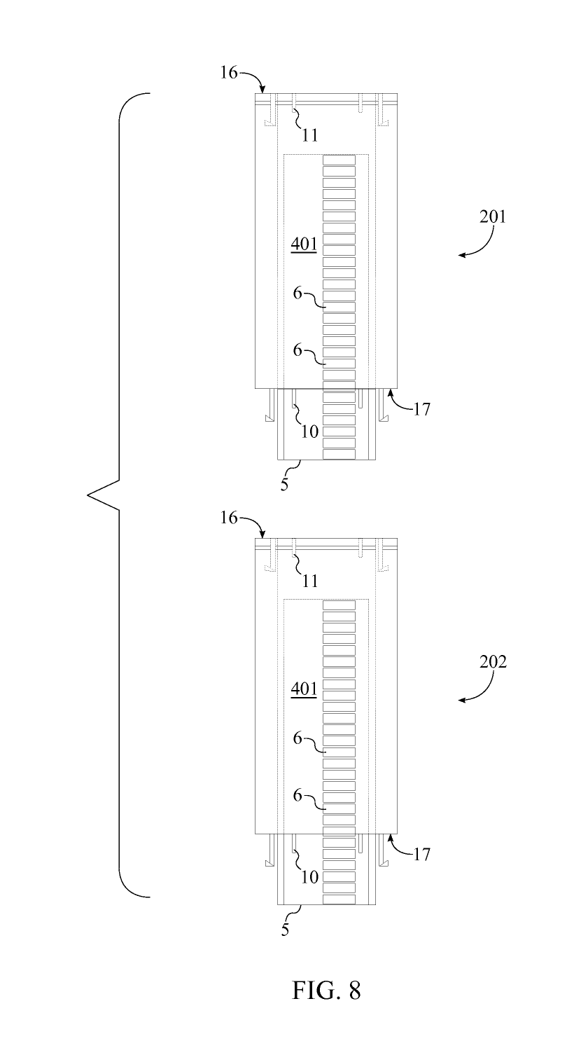

In the segmented embodiment illustrated in FIGS. 5, 6, and 7, the primary feature is that the lateral enclosure 1 is a plurality segmented portions 15, each of which has a corresponding sensor array 401 from the plurality of sensor arrays 2. The plurality of segmented portions 15 is serially interlocked with each other, and the number of segmented portions 15 that need to be serially interlocked depends on the height of the storage tank. Each of the plurality of segmented portions 15 comprises a top rim 16 and a bottom rim 17, which delineate opposite openings for each segmented portion 15. The top board edge 4 of the corresponding sensor array 401 is recessed from the top rim 16 by an offset distance 402, and the bottom board edge 5 is protruded from the bottom rim 17 by the offset distance 402, which allows the plurality of segmented portions 15 to couple into each other. As can be seen in FIG. 8, the bottom board edge 5 of an arbitrary segmented portion 201 traverses through the top rim 16 of an adjacent segmented portion 202, which allows the bottom board edge 5 of the arbitrary segmented portion 201 to be positioned against the top board edge 4 of the adjacent segmented portion 202. In some versions of the segmented embodiment, each of the segmented portions 15 comprises a D-ring 501, a D-groove 502, locking clips 503, and receiving sockets 504. The D-ring 501 and the D-groove 502 are positioned opposite of each other on each segmented portion 15, and the D-ring 501 of an arbitrary segmented portion 201 would engage the D-groove 502 of an adjacent segmented portion 202 in order to interlock the arbitrary segmented portion 201 and the adjacent segmented portion 202. The locking clips 503 and the receiving sockets 504 are positioned opposite of each other on each segmented portion 15, and the locking clips 503 of an arbitrary segmented portion 201 would engage the receiving sockets 504 of an adjacent segmented portion 202 in order to further interlock the arbitrary segmented portion 201 and the adjacent segmented portion 202.

The components of present invention can be made of any materials that are suitable towards their functionality. In the preferred embodiment, the components of the present invention are made of materials that improve their functionality. The lateral enclosure 1 can be made of plastic or non-magnetic metal depending on the application of the present invention. For more benign environments, polyvinyl chloride (PVC) can be used for the lateral enclosure 1. For more aggressive environments, fluorinated ethylene propylene (FEP) can be used for the lateral enclosure 1. The circuit board 3 is made of, but is not limited to, a FR-4 glass proxy or polyimide. The magnetic float 12 can comprise a dense plastic housing that positions magnets to properly trigger the plurality of Hall-Effect sensors 6.

The power sequence can be described as follows: On first power-up, the central controller 13 will query each of plurality of sensor arrays 2 to determine the location of the floats. Once the location of the floats is determined, the central controller 13 will power down (into low power sleep mode) all sensor arrays that did not detect the presence of the magnetic float 12. The sensor array that did detect the magnetic float 12 will only power the active Hall-Effect sensors and one or two Hall-Effect sensors 6 above and below the active Hall-Effect sensor. The active sensors will then go to sleep, waiting for a change in float position. This power management algorithm provides highly efficient power control and minimizes power consumption for battery operated systems.

Since this system is extremely flexible, it can remain powered up at all times if it is powered externally and power consumption is not a critical operating parameter.

The power management algorithm can also work when the float is between two sensors. This function works as follows: If a float is between two Hall-Effect sensors 6, both Hall-Effect sensors 6 will be active “on” and only these sensors will be powered. If the magnetic float 12 moves, then one Hall-Effect sensor will go “off”, which will wake up the system since a change has been detected.

The present invention is designed to operate in conjunction with the central controller 13. The microcontroller 7 on each sensor array 2 manages the power for that sensor array. If a change is detected on a particular sensor array, that sensor array will assert the notification signal to wake up the central controller 13. The central controller 13 then queries the sensor arrays 2 to determine the new location of the magnetic float 12. Once the new location has been determined, the present invention will go back to sleep until another change event occurs.

Although the invention has been explained in relation to its preferred embodiment, it is to be understood that many other possible modifications and variations can be made without departing from the spirit and scope of the invention as hereinafter claimed.

What is claimed is:

1. A system for measuring a liquid surface level within a storage tank:
a lateral enclosure;
a plurality of sensor arrays;
an at least one magnetic float;
a central controller;
each of said plurality of sensor arrays comprises a circuit board, a plurality of Hall-Effect sensors, and a microcontroller;
said plurality of sensor arrays being serially mounted within said lateral enclosure;
said plurality of sensor arrays being daisy chained together;
said plurality of Hall-Effect sensors being serially mounted onto said circuit board, along said lateral enclosure;
said plurality of Hall-Effect sensors being systematically spaced apart from each other by a set interval on said circuit board;
said magnetic float being exteriorly positioned around and slidably engaged to said lateral enclosure;
said microcontroller being electrically connected to each of said plurality of Hall-Effect sensors; and
said microcontroller for each of said plurality of sensor arrays being communicably coupled to said central controller.

2. The system for measuring a liquid surface level within a storage tank as claimed in claim 1 comprises:
each of said plurality of sensor arrays further comprises a temperature sensor;
said temperature sensor being mounted onto said circuit board; and
said temperature sensor being electronically connected to said microcontroller.

3. The system for measuring a liquid surface level within a storage tank as claimed in claim 1 comprises:
each of said plurality of sensor arrays further comprises a regulator;
said regulator being mounted onto said circuit board; and
said microcontroller being electronically connected to each of said plurality of Hall-Effect sensors through said regulator.

4. The system for measuring a liquid surface level within a storage tank as claimed in claim 1 comprises:
each of said plurality of sensor arrays further comprises a male interconnector and a female interconnector;
said male interconnector and said female interconnector being mounted onto said circuit board, opposite to each other;
said male interconnector being electronically connected to said microcontroller; and
said female interconnector being electronically connected to said microcontroller.

5. The system for measuring a liquid surface level within a storage tank as claimed in claim 1 comprises:
said plurality of sensor arrays comprises an arbitrary sensor array and an adjacent sensor array; and
a male interconnector of said arbitrary sensor array being electronically engaged to a female interconnector of said adjacent sensor array.

6. The system for measuring a liquid surface level within a storage tank as claimed in claim 1 comprises:
said at least one magnetic float being a plurality of magnetic floats; and
each of said plurality of magnetic floats being a different buoyancy weight.

7. The system for measuring a liquid surface level within a storage tank as claimed in claim 1 comprises:
a top cap;
a bottom cap;
said lateral enclosure being non-segmented;
said top cap being perimetrically connected adjacent to said lateral enclosure; and
said bottom cap being perimetrically connected adjacent to said lateral enclosure, opposite to said top cap.

8. The system for measuring a liquid surface level within a storage tank as claimed in claim 7 comprises:
said plurality of Hall-Effect sensors comprises a first sensor and a last sensor;
said circuit board comprises a top board edge and a bottom board edge;
said first sensor being offset from said top board edge by half of said set interval; and
said last sensor being offset from said bottom board edge by half of said set interval.

9. The system for measuring a liquid surface level within a storage tank as claimed in claim 1 comprises:
said lateral enclosure being a plurality of segmented portions;
each of said plurality of segmented portions comprises a corresponding sensor array from said plurality of sensor arrays; and
said plurality of segmented portions being serially interlocked with each other.

10. The system for measuring a liquid surface level within a storage tank as claimed in claim 9 comprises:
each of said plurality of segmented portions comprises a top rim and a bottom rim;
said circuit board comprises a top board edge and a bottom board edge;
said top board edge of said corresponding sensor array being recessed from said top rim by an offset distance; and
said bottom board edge of said corresponding sensor array being protruded from said bottom rim by said offset distance.

11. The system for measuring a liquid surface level within a storage tank as claimed in claim 9 comprises:
said plurality of segmented portions comprises an arbitrary segmented portion and an adjacent segmented portion;
each of said plurality of segmented portions comprises a top rim and a bottom rim;
said circuit board comprises a top board edge and a bottom board edge;
said bottom board edge of said arbitrary segmented portion traversing through said top rim of said adjacent segmented portion; and
said bottom board edge of said arbitrary segmented portion being positioned against said top edge of said adjacent portion.

12. A power management method for the system claimed in claim 1, the method comprises the steps of:
(A) locating said magnetic float along said plurality of sensor arrays by querying each of said plurality of sensor arrays;
(B) designating at least one of said plurality of sensor arrays nearest to said magnetic float as an active sensor array;
(C) powering down each of said plurality of sensor arrays except for said active sensor array;
(D) locating said magnetic float along said plurality of Hall-Effect sensors for said active sensor by receiving a detection signal from said plurality of Hall-Effect sensors;
(E) designating at least one of said plurality of Hall-Effect sensors nearest to said magnetic float as an active Hall-Effect sensor;
(F) powering down each of said plurality of Hall-Effect sensors for said active sensor array except for said active Hall-Effect sensor; and
(G) repeating steps (A) through (F), if said magnetic float relocates along said plurality of sensor arrays or relocates along said plurality of Hall-Effect sensors for said active sensor array.

13. The power management method for the system claimed in claim 1, wherein one or two Hall-Effect sensors above and below said active Hall-Effect sensor remains active.

14. The power management method for the system claimed in claim 1, wherein a notification signal is sent from said microcontroller of said active sensor array in order to communicate a relocation of said magnetic float.

15. A system for measuring a liquid surface level within a storage tank:
a lateral enclosure;
a plurality of sensor arrays;
an at least one magnetic float;
a central controller;
each of said plurality of sensor arrays comprises a circuit board, a plurality of Hall-Effect sensors, and a microcontroller;
said plurality of sensor arrays being serially mounted within said lateral enclosure;
said plurality of sensor arrays being daisy chained together;
said plurality of Hall-Effect sensors being serially mounted onto said circuit board, along said lateral enclosure;
said plurality of Hall-Effect sensors being systematically spaced apart from each other by a set interval on said circuit board;
said magnetic float being exteriorly positioned around and slidably engaged to said lateral enclosure;
said microcontroller being electrically connected to each of said plurality of Hall-Effect sensors;
said microcontroller for each of said plurality of sensor arrays being communicably coupled to said central controller;
said at least one magnetic float being a plurality of magnetic floats; and
each of said plurality of magnetic floats being a different buoyancy weight.

16. The system for measuring a liquid surface level within a storage tank as claimed in claim 15 comprises:
each of said plurality of sensor arrays further comprises a temperature sensor and a regulator;
said temperature sensor being mounted onto said circuit board;
said temperature sensor being electronically connected to said microcontroller;
said regulator being mounted onto said circuit board; and
said microcontroller being electronically connected to each of said plurality of Hall-Effect sensors through said regulator.

17. The system for measuring a liquid surface level within a storage tank as claimed in claim 15 comprises:
said plurality of sensor arrays comprises an arbitrary sensor array and an adjacent sensor array;
each of said plurality of sensor arrays further comprises a male interconnector and a female interconnector;
said male interconnector and said female interconnector being mounted onto said circuit board, opposite to each other;
said male interconnector being electronically connected to said microcontroller;
said female interconnector being electronically connected to said microcontroller; and
said male interconnector of said arbitrary sensor array being electronically engaged to said female interconnector of said adjacent sensor array.

18. The system for measuring a liquid surface level within a storage tank as claimed in claim 15 comprises:
a top cap;
a bottom cap;
said plurality of Hall-Effect sensors comprises a first sensor and a last sensor;
said circuit board comprises a top board edge and a bottom board edge;
said lateral enclosure being non-segmented;
said top cap being perimetrically connected adjacent to said lateral enclosure;
said bottom cap being perimetrically connected adjacent to said lateral enclosure, opposite to said top cap;
said first sensor being offset from said top board edge by half of said set interval; and
said last sensor being offset from said bottom board edge by half of said set interval.

19. The system for measuring a liquid surface level within a storage tank as claimed in claim 15 comprises:
said lateral enclosure being a plurality of segmented portions;
each of said plurality of segmented portions comprises a corresponding sensor array from said plurality of sensor arrays;
each of said plurality of segmented portions comprises a top rim and a bottom rim;
said circuit board comprises a top board edge and a bottom board edge;
said plurality of segmented portions being serially interlocked with each other;
said top board edge of said corresponding sensor array being recessed from said top rim by an offset distance; and
said bottom board edge of said corresponding sensor array being protruded from said bottom rim by said offset distance.

20. The system for measuring a liquid surface level within a storage tank as claimed in claim 19 comprises:
said plurality of segmented portions comprises an arbitrary segmented portion and an adjacent segmented portion;
said bottom board edge of said arbitrary segmented portion traversing through said top rim of said adjacent segmented portion; and
said bottom board edge of said arbitrary segmented portion being positioned against said top edge of said adjacent portion.
